(19) United States
(12) Patent Application Publication
(10) Pub. No.: US 2003/0155504 A1
(43) Pub. Date: Aug. 21, 2003

(54) Radiative sample warming for an ion mobility spectrometer

(76) Inventors: Viatcheslav S. Motchkine, Moscow (RU); Leonid Y. Krasnobaev, Newton, MA (US); Stephen N. Bunker, Wakefield, MA (US)

Correspondence Address: PATENT GROUP, CHOATE, HALL & STEWART, EXCHANGE PLACE, 53 STATE STREET, BOSTON, MA, 02109, US

(21) Appl. No.: 10/295,039

(22) Filed: Nov. 14, 2002

Related U.S. Application Data
(60) Provisional application No. 60/357,394, filed on Feb. 15, 2002.
(60) Provisional application No. 60/357,618, filed on Feb. 15, 2002.
(60) Provisional application No. 60/363,485, filed on Mar. 12, 2002.

(51) Int. Cl. H01S 3/091; H01J 49/00; B01D 59/44

(52) U.S. Cl. 250/287

(57) ABSTRACT

The presence of trace molecules in air is often determined using a well-known device called an ion mobility spectrometer. Such devices are commonly utilized in the fields of explosives detection, identification of narcotics, and in applications characterized by the presence of very low airborne concentrations of organic molecules of special interest. The sensitivity of such instruments is dependent on the concentration of target gas in the sample. The sampling efficiency can be greatly improved when the target object is warmed, even by only a few degrees. A directed emission of photons, typically infrared or visible light, can be used to significantly enhance vapor emission.

### CROSS-REFERENCE TO RELATED APPLICATIONS

This application claims benefit and priority from U.S. Provisional Application No. 60/357,394, filed Feb. 15, 2002, U.S. Provisional Application No. 60/357,618, filed Feb. 15, 2002, and U.S. Provisional Application No. 60/363,485, filed Mar. 12, 2002, all of which are incorporated herein by reference.

### BACKGROUND OF THE INVENTION

1. Field of the Invention

This invention relates to an ion mobility spectrometry instrument that detects chemicals present as vapors in air or other gases, or liberated as vapors from condensed phases such as particles or solutions. It particularly relates to increasing the sampling concentration of such vapors for injection into the ion source of the ion mobility spectrometer (IMS) using photonic energy for warming the target.

2. Description of Related Art

IMS instruments operate on the basis of the time taken by ionized molecules to move through a gas-filled drift region to a current collector while under the influence of an electric field. The ions are created in a gas-filled region called the ion source, which is connected to the drift region through an orifice or a barrier grid. The ion source may use any of a variety of techniques to ionize atoms and molecules. One or more flowing streams of gas enter the ion source through one or more orifices, and the gas may exit through one or more different orifices. At least one of the flowing gas streams entering the ion source includes gas that has been sampled (the “sample gas”) from the surrounding atmosphere or other source of vapor to be analyzed.

In same cases, the process of taking a sample begins with an operator rubbing an absorbent substance, such as chemical filter paper, onto the surface to be tested. Particles of the chemical of interest may then be transferred and concentrated on the absorber. This intermediate absorber is then brought to the vicinity of the sampling orifice of the IMS. The method of concentrating using an absorbent substance is deficient in that it tends to be relatively slow to implement and is subject to variations in the skill of the operator. Additionally, while the absorber is relatively low in cost, the process of taking a great many samples becomes expensive in that the absorber generally should only be used once to ensure consistent results.

The quantity of particles of the target substance on the target surface is usually very small, often corresponding to only nanograms or even picograms of particles per square centimeter. The IMS must be very sensitive to identify a positive signal from evaporated target molecules when the initial concentration and surface area of target particles is so small.

A sampling method that is employed is to provide a gas pump, which draws the sample gas into the ion source through a tube. For example, the pump may be disposed to provide a partial vacuum at the exit of the ion source. The partial vacuum is transmitted through the confines of the ion source and appears at the entrance orifice of the ion source. A further tubulation may be provided as an extension to a more conveniently disposed sampling orifice external to the IMS. The operator places a sample in the near vicinity of this external sampling orifice, and the ambient vapor is drawn into the gas flow moving towards the ion source.

The ion source of the IMS provides a signal that is approximately proportional to the concentration of target molecule vapor. This concentration is further dependent on the equilibrium vapor pressure of the target molecule, the temperature of the target molecule where it is emitting the vapor, the total flow rate of non-target gas that dilutes the target vapor, and possible adsorption losses on surfaces of the gas sampling system. Existing systems that utilize absorbent surface concentration sometimes employ an oven to greatly warm the absorbent material, often up to 200°, and thereby increase the target vapor concentration.

In some circumstances, it is desirable for IMS instruments to be able to sample vapors at a distance from the external sampling orifice. Examples may include, but not be limited to, sampling of vapor from complex surfaces that contain many holes, crevices, or deep depressions, textured materials such as cloth, people and animals that prefer not to be rubbed by absorbent material, large three dimensional objects, surfaces that must be sampled in a short time, and surfaces in which surface rubbing by human operators is inconvenient or expensive. In addition, it has been observed that the sampling orifice may become contaminated with vapor-emitting particles if the sample inadvertently contacts the orifice. Such contamination is particularly difficult to remove in a short period of time, thus preventing continuous operation of the instrument. Such contamination could be avoided if vapors are sampled at a distance from the sampling orifice.

The distance where vapors may be sampled beyond the sampling orifice may be increased by increasing the sample gas flow rate, i.e., increasing the pumping speed. However, besides the interference with the performance of the ion source of the IMS caused by high velocity flow, this method dilutes the concentration of the desired sample vapor by mixing in a much larger volume of ambient gas. Therefore, the sensitivity of the IMS may decline if the sample gas flow rate is increased excessively.

Warming surfaces at a distance using an oven is generally not very efficient. While warmed gas can be blown onto a distant surface, for example with a “heat gun”, when the target surface is a living person or animal, this may not be an acceptable option. Additionally, many surfaces cannot tolerate excessive heating and may be damaged.

### SUMMARY OF THE INVENTION

According to the present invention, a target sample heating system for an ion mobility spectrometer includes a source of photon emission substantially in the infrared portion of the spectrum, means for concentrating the photon emission into a beam, and means for guiding the photon emission towards a target surface. The source of photon emission may be at least one of: a thermally heated surface, laser, light emitting diode, and an electrical discharge in a gas. The source of photon emission may be at least one of: pulsed, keyed in a long pulse, and continuous. The means for concentrating the photon emission may be at least one of a mirror, lens, and fiber optic wave guide. The means for guiding the photon emission towards a target surface may be at least one of a mirror, lens, and fiber optic wave guide. The means for guiding said photon emission may be moved or tilted while guiding the photon emission. The source of photon emission may be made to be substantially in the infrared using at least one of a filter, coating, and covering. The source of photon emission may have enhanced emission substantially in the infrared by means of conversion of visible light photons to infrared photons. The source of photon emission may be separated from the target surface by at least one of a window and a semi-transparent grid.

According further to the present invention, a target sample heating system for an ion mobility spectrometer includes a source of photon emission substantially in the combined visible and infrared portion of the spectrum, means for concentrating the photon emission into a beam, and means for guiding the photon emission towards a target surface. The source of photon emission may be at least one of a thermally heated surface, a laser, light emitting diode, and an electrical discharge in a gas. The source of photon emission may be at least one of: pulsed, keyed in a long pulse, and continuous. The means for concentrating the photon emission may be at least one of a mirror, lens, and fiber optic wave guide. The means for guiding the photon emission towards a target surface may be at least one of a mirror, lens, and fiber optic wave guide. The means for guiding the photon emission may be moved or tilted while guiding the photon emission. The source of photon emission may be separated from the target surface by at least one of a window and a semi-transparent grid.

According further to the present invention, a target sample heating system for an ion mobility spectrometer includes a source of photon emission substantially in the visible portion of the spectrum, means for concentrating said photon emission into a beam, and means for guiding said photon emission towards a target surface. The source of photon emission may be at least one of a thermally heated surface, a laser, light emitting diode, and an electrical discharge in a gas. The source of photon emission may be at least one of: pulsed, keyed in a long pulse, and continuous. The means for concentrating the photon emission may be at least one of mirror, lens, and fiber optic wave guide. The means for guiding the photon emission towards a target surface may be at least one of a mirror, lens, and fiber optic wave guide. The means for guiding the photon emission may be moved or tilted while guiding said photon emission. The source of photon emission may be made to be substantially in the visible using at least one of a filter, coating, and covering. The source of photon emission may be separated from the target surface by at least one of a window and a semi-transparent grid.

According further to the present invention, a sampling system for an IMS includes a gas sampling inlet that samples vapors from a target and provides the vapors to the IMS and a heat source, mounted proximal to the gas sampling inlet, the heat source providing photonic emissions to the target in connection with the inlet sampling vapors. The photonic emissions may be substantially in the infrared portion of the spectrum. The source of photon emission may be made to be substantially in the infrared using at least one of a filter, coating, and covering. The source of photon emission may have enhanced emission substantially in the infrared by means of conversion of visible light photons to infrared photons. The photonic emissions may be substantially in the combined visible and infrared portion of the spectrum. The photonic emissions may be substantially in the visible portion of the spectrum. The source of photon emission may be made to be substantially in the visible using at least one of a filter, coating, and covering. The photonic emissions may be provided by at least one of a thermally heated surface, a laser, a light emitting diode, and an electrical discharge in a gas. The source of photon emission may be at least one of: pulsed, keyed in a long pulse, and continuous. The source of photon emission may be separated from the target surface by at least one of a window and a semi-transparent grid.

The invention applies to an ion mobility spectrometer that uses an external sampling orifice to draw in vapors to be analyzed. A method for warming a distant target surface is described using at least one of several techniques. The goal is to heat the target surface in a manner such that the action of heating is unobtrusive, perhaps invisible, the sampled portion of the surface is warmed at least 5° C., and only the surface is warmed, not the bulk of the target material. These conditions may be accomplished using one or more infrared light sources, one or more visible light sources, or a mixture of the two. A light source that is substantially in the infrared portion of the spectrum has the advantage that it is largely invisible to the eye, except for a slight reddish appearance. However, brighter light sources, that warm the surface more quickly, can be produced more easily using visible light. Infrared wavelengths are generally considered to be longer than 700 nanometers and shorter than 100 micrometers. Visible wavelengths are generally considered to be in the range of 700 nanometers to 300 nanometers. Most sources of visible light produce some small percentage of ultraviolet light less than 300 nanometers and some small percentage of infrared light. Most light sources, except lasers, produce broad distributions of wavelengths, and a source is considered to be a visible light source if the peak of its distribution is in the visible range of wavelengths.

It is preferable to utilize means for guiding and concentrating the photon beam from the light source towards the place on the target surface where gas sampling is most efficiently being performed in order to minimize the power consumption, heat primarily the target surface of interest, and maximize the lifetime of the light source. Said means may be in the form of one or more lenses, one or more mirrors, fiber optic cable, or some combination of these. An example would consist of a parabolic mirror combined with a nearly point source of infrared light. With the point source situated near to the focal point of the mirror, a substantially parallel infrared beam results, which can then be directed at the desired location on the target surface.

The source of light may be continuous or pulsed. Pulsed light has the advantage of conserving energy and avoiding overheating of the target surface. A desirable feature is to turn off the light source when not in use, but a continuous output light source often requires time to come to stable operating conditions. An alternate embodiment would be to combine a shutter with the continuous output light source in order to simulate a pulsed source. Equivalently, the source of light may be pulsed with a long duration on the order of seconds, sometimes referred to as “keyed”.

The interaction of the light radiation with the particles of target material depends on the wavelength of radiation employed. At some wavelengths, the target particles may substantially reflect the incident radiation, thus not absorbing energy and becoming warmed. Heating is then accomplished indirectly by using the incident radiation to warm the surface on which the target particles are attached with heat being transferred to the target particles by conduction, convection, or conversion of the incident wavelength to one that is substantially longer where the target molecules are more absorptive.

There are many well-known sources of infrared and visible light that may be utilized. A hot wire, possible heated electrically, may be used for infrared emission. The wire temperature may be near 800° C. to 850° C. when operated in air. An example of a pulsed visible light source is a xenon flash lamp, in which the pulse duration in one embodiment is approximately 10⁻⁴ seconds. Laser light sources are available both pulsed and continuous at single wavelengths covering much of the infrared and visible light spectrum.

### BRIEF DESCRIPTION OF THE DRAWING

The invention is described with reference to the several figures of the drawing, in which,

FIG. 1 is a schematic of an IMS detector that may be used in connection with the system disclosed herein.

FIG. 2A is a schematic diagram showing a possible embodiment for a radiative target sample heating unit that uses an electrically heated coil of wire at the focus of a parabolic reflector.

FIG. 2B is a schematic diagram showing a possible embodiment for a radiative target sample heating unit that uses a pulsed visible light lamp near the focus of a parabolic reflector.

FIG. 2C is a schematic diagram showing a possible embodiment for a radiative target sample heating unit that uses a toroidal heated coil of wire within a component of a gas cyclone used in gas sampling.

FIG. 2D is a schematic diagram showing a possible embodiment for a radiative target sample heating unit that uses a pulsed visible light lamp within a component of a gas cyclone used in gas sampling.

FIG. 3 shows a possible embodiment showing the focused light beams from a pair of pulsed visible light parabolic reflection modules aimed at a common location in front of the gas sampling orifice of the IMS.

FIG. 4A is a schematic showing a possible embodiment for transmission of the photon beam using fiber optic light guides.

FIG. 4B is a schematic showing a possible embodiment for filtering of the photon beam using a cold mirror.

FIG. 5 is a schematic showing a possible embodiment for scanning the photon beam or beams using one or more moving hot mirrors.

### DETAILED DESCRIPTION

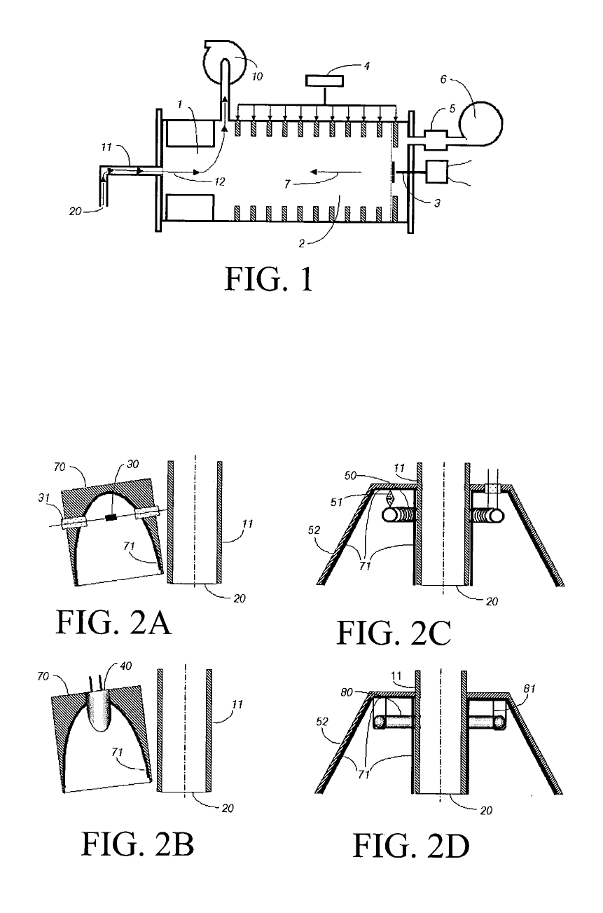

An IMS is illustrated in FIG. 1. While various embodiments may differ in details, FIG. 1 shows basic features of an IMS that may be used in connection with the system described herein. The IMS includes an ion source 1, a drift tube 2, a current collector 3, a source of operating voltage 4 and a source of purified drift gas 5, possibly with it own gas pump 6. An IMS may already include a gas pump for gas sampling 10 and a tubular connection 11 between the ion source 1 and an external gas sampling inlet 20 that includes an orifice. Gas flow for the drift gas 7 moves through the drift tube 2. Sampling gas flow 12 moves from the external gas sampling inlet 20 through the tubular connection 11 and ion source 1 to the gas sampling pump 10.

FIGS. 2A-2D show a selection of possible embodiments for a radiative heating element, provided proximal to the gas sampling inlet 20, that heats the target surface in conjunction with the gas sampling system of the IMS. In FIG. 2A, the technique for heating combines a continuous electrically heated wire 30, which emits substantially in the infrared, with a parabolic reflector 70. The coil of heated wire is disposed at or near the focal point of the reflector in order to form a beam of photons that is substantially parallel. The coil 30 may also be disposed slightly offset of the focal point of the reflector in order to form a beam cross section that is either slightly converging or diverging, depending on the target area of interest. The electrically heated wire 30 is electrically insulated from the reflector 70 by means of insulators 31. The reflector 70 may optionally be polished and optionally coated with a reflective material 71. The electrically heated wire may also be optionally disposed within a sealed enclosure, such as an evacuated transparent glass bulb.

In FIG. 2B, the light source is provided by a miniature pulsed xenon gas-filled lamp 40. A parabolic reflector 70 is shown with a coating of a reflective material 71. In FIG. 2C, a conical reflector 52 is employed which may also be a component of the gas sampling system of the IMS, such as a cyclone nozzle. The infrared radiation is produced by a toroidally-shaped coil of electrically heated wire 50, which is mounted on insulators 51. In FIG. 2D, the reflector is similar to that for FIG. 2C, but the light is provided by a toroidally-shaped pulsed xenon lamp 80 mounted on wires 81.

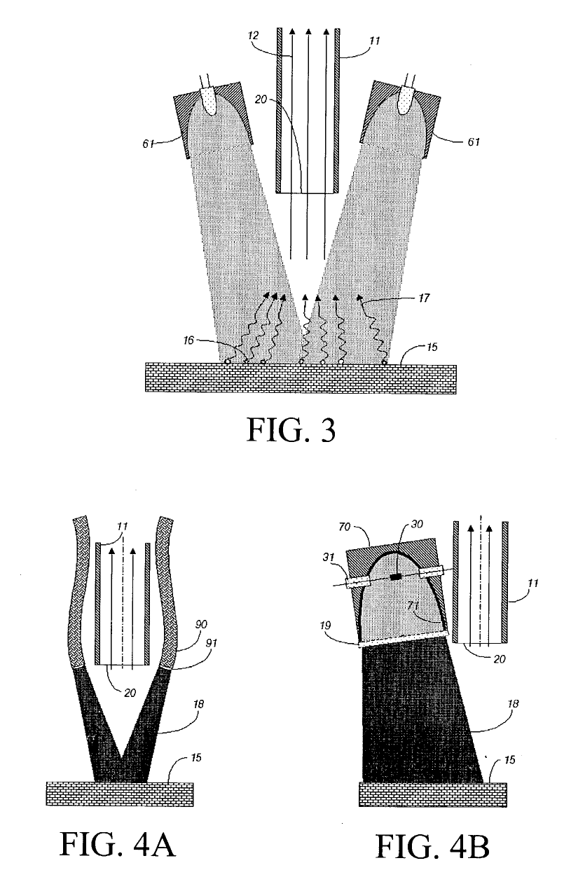

FIG. 3 shows a possible embodiment in the form of two pulsed visible light lamp modules 61 mounted proximal to the tubular connection 11 to the IMS and to the gas sampling inlet 20. The lamp modules 61 focus their photon beams 18 onto the target surface 15, heating target particles 16 and causing the enhanced emission of target molecule vapors 17. The target molecule vapors 17 are entrained in the gas flow 12 entering the gas sampling inlet 20. Different numbers of the same or different types of heating modules may be used.

Light sources that produce a spectrum of wavelengths substantially in the visible band may optionally be coated, filtered, or covered with infrared-enhancing materials in order to increase the infrared fraction of the output spectrum. Such materials may act as transmission filters in which the infrared component is selectively passed, or they may alternatively convert a portion of the incident visible light photons to infrared photons, possibly by heating a secondary surface to a high temperature. Similarly, evacuated glass bulbs that have output primarily in visible light may have surface coatings, internal gases, or filters to increase the infrared fraction of the output spectrum. The filter, coating, or covering may optionally be in the form of a mirror that selectively reflects infrared, commonly called a “hot mirror”. Alternatively, the filter, coating, or covering may be a “cold mirror” that reflects visible but transmits infrared, particularly as a protective window. Such protective windows are useful for isolating hot or delicate sources of light radiation. In addition to a cold mirror, a transparent window or open mesh grid may also be used as a protective window.

FIGS. 4A and 4B show other possible embodiments for transmitting the photon beam or beams to the target surface 15. In FIG. 4A, fiber optic light guides 90 are disposed proximal to the tubular connection 11 to the IMS and to the gas sampling inlet 20. In the embodiment shown, a lens 91 is employed to minimize the divergence of the photon beam 18 being emitted by the fiber optic cable 90. The photon beams 18 are aimed at positions on the target surface 15 to enhance the emission of target molecule vapor. The positions may optionally be selected to overlap and reinforce one another or to illuminate separate locations. In FIG. 4B, a cold mirror 19 may be employed together with the light module of FIG. 2A in order to enhance the infrared fraction of the photon beam 18.

Fiber optics or similar light guides may be used to separate the location of light generation and the illumination of the target surface to permit physically larger lamps than would be possible nearer to the sampling inlet 20. Moving mirrors may be used to scan the infrared or visible optical beam in order to define a larger irradiated surface area. A variable focus lens or the position of the optical source relative to the mirror may be utilized to change the optical beam cross section or to selectively focus the optical beam at a particular distance.

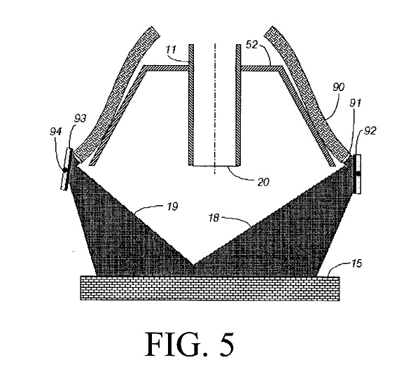

FIG. 5 show a possible embodiment for transmitting the photon beam or beams to the target surface 15 when a conical nozzle 52 for a cyclone is employed, such as the disclosed in provisional patent application No. 60/357,394. In this embodiment, hot mirrors 93 reflect the photon beam 18 emitted from fiber optic cables 90. A lens 91 is employed to focus the photon beam 18, although in an alternate embodiment the hot mirror 93 could have a concave surface to accomplish similar focusing control. The hot mirrors 93 may also be optionally tilted about axis 94 in order to scan the photon beam 18 across the target surface 15.

Other methods of optical emission, transmission, filtering, and focusing are possible, and the specifically described embodiments should not be understood as restricting the scope of the invention.

The IMS instrument described herein may incorporate other novel features, such as the cyclone sampling described in copending and commonly assigned U.S. Provisional Application No. 60/357,394, filed Feb. 15, 2002, or the electrostatic particle sampling system described in copending and commonly assigned U.S. Provisional Application No. 60/363,485, filed Mar. 12, 2002. These related provisional applications are incorporated by reference herein.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A target sample heating system for an ion mobility spectrometer comprising:
a source of photon emission substantially in the infrared portion of the spectrum;
means for concentrating said photon emission into a beam; and
means for guiding said photon emission towards a target surface.

2. The target sample heating system of claim 1, wherein said source of photon emission is at least one of: a thermally heated surface, laser, light emitting diode, and an electrical discharge in a gas.

3. The target sample heating system of claim 1, wherein said source of photon emission is at least one of: pulsed, keyed in a long pulse, and continuous.

4. The target sample heating system of claim 1 wherein said means for concentrating said photon emission is at least one of a mirror, lens, and fiber optic wave guide.

5. The target sample heating system of claim 1, wherein said means for guiding said photon emission towards a target surface is at least one of a mirror, lens, and fiber optic wave guide.

6. The target sample heating system of claim 5, wherein said means for guiding said photon emission is moved or tilted while guiding said photon emission.

7. The target sample heating system of claim 1, wherein said source of photon emission is made to be substantially in the infrared using at least one of a filter, coating, and covering.

8. The target sample heating system of claim 1, wherein said source of photon emission has enhanced emission substantially in the infrared by means of conversion of visible light photons to infrared photons.

9. The target sample heating system of claim 1, wherein said source of photon emission is separated from said target surface by at least one of a window and a semi-transparent grid.

10. A target sample heating system for an ion mobility spectrometer comprising:
a source of photon emission substantially in the combined visible and infrared portion of the spectrum;
means for concentrating said photon emission into a beam; and
means for guiding said photon emission towards a target surface.

11. The target sample heating system of claim 10, wherein said source of photon emission is at least one of a thermally heated surface, a laser, light emitting diode, and an electrical discharge in a gas.

12. The target sample heating system of claim 10, wherein said source of photon emission is at least one of: pulsed, keyed in a long pulse, and continuous.

13. The target sample heating system of claim 10, wherein said means for concentrating said photon emission is at least one of a mirror, lens, and fiber optic wave guide.

14. The target sample heating system of claim 10, wherein said means for guiding said photon emission towards a target surface is at least one of a mirror, lens, and fiber optic wave guide.

15. The target sample heating system of claim 10, wherein said means for guiding said photon emission is moved or tilted while guiding said photon emission.

16. The target sample heating system of claim 10, wherein said source of photon emission is separated from said target surface by at least one of a window and a semi-transparent grid.

17. A target sample heating system for an ion mobility spectrometer comprising:
a source of photon emission substantially in the visible portion of the spectrum;
means for concentrating said photon emission into a beam; and
means for guiding said photon emission towards a target surface.

18. The target sample heating system of claim 17, wherein said source of photon emission is at least one of a thermally heated surface, a laser, light emitting diode, and an electrical discharge in a gas.

19. The target sample heating system of claim 17, wherein said source of photon emission is at least one of: pulsed, keyed in a long pulse, and continuous.

20. The target sample heating system of claim 17, wherein said means for concentrating said photon emission is at least one of mirror, lens, and fiber optic wave guide.

21. The target sample heating system of claim 17, wherein said means for guiding said photon emission towards a target surface is at least one of a mirror, lens, and fiber optic wave guide.

22. The target sample heating system of claim 17, wherein said means for guiding said photon emission is moved or tilted while guiding said photon emission.

23. The target sample heating system of claim 17, wherein said source of photon emission is made to be substantially in the visible using at least one of a filter, coating, and covering.

24. The target sample heating system of claim 17, wherein said source of photon emission is separated from said target surface by at least one of a window and a semi-transparent grid.

25. A sampling system for an IMS, comprising:
a gas sampling inlet that samples vapors from a target and provides the vapors to the IMS; and
a heat source, mounted proximal to the gas sampling inlet, the heat source providing photonic emissions to the target in connection with the inlet sampling vapors.

26. A sampling system, according to claim 25, wherein the photonic emissions are substantially in the infrared portion of the spectrum.

27. A sampling system, according to claim 26, wherein said source of photon emission is made to be substantially in the infrared using at least one of a filter, coating, and covering.

28. A sampling system, according to claim 26, wherein said source of photon emission has enhanced emission substantially in the infrared by means of conversion of visible light photons to infrared photons.

29. A sampling system, according to claim 25, wherein the photonic emissions are substantially in the combined visible and infrared portion of the spectrum.

30. A sampling system, according to claim 25, wherein the photonic emissions are substantially in the visible portion of the spectrum.

31. A sampling system, according to claim 30, wherein said source of photon emission is made to be substantially in the visible using at least one of a filter, coating, and covering.

32. A sampling system, according to claim 25, wherein the photonic emissions are provided by at least one of a thermally heated surface, a laser, a light emitting diode, and an electrical discharge in a gas.

33. A sampling system, according to claim 22, wherein said source of photon emission is at least one of: pulsed, keyed in a long pulse, and continuous.

34. A sampling system, according to claim 25, wherein said source of photon emission is separated from said target surface by at least one of a window and a semi-transparent grid.
